(19) United States
(12) Patent Application Publication
(10) Pub. No.: US 2023/0299402 A1
(43) Pub. Date: Sep. 21, 2023

(54) SUSTAINABLE POWER MODULE

(71) Applicant: LiiON, LLC, East Dundee, IL (US)

(72) Inventors: Gary GRAY, Tarpon Springs, FL (US); Thomas LYNN, Malvern, PA (US); Christopher Jason MAKSYM, Canton, MI (US)

(73) Assignee: LiiON, LLC, East Dundee, IL (US)

(21) Appl. No.: 18/115,360

(22) Filed: Feb. 28, 2023

Related U.S. Application Data
(60) Provisional application No. 63/314,792, filed on Feb. 28, 2022.

(51) Int. Cl. H01M 50/204; H01M 50/507; H01M 50/258; H01M 50/522; H01M 50/519; H01M 50/271

(52) U.S. Cl. CPC H01M 50/204; H01M 50/507; H01M 50/258; H01M 50/522; H01M 50/519; H01M 50/271; H01M 50/516

(57) ABSTRACT

A power pack module including a power core including a plurality of energy cells, a shell encasing the power core, the shell formed from a pair of interlocking half-shell members, and a weld plate affixed to the shell.

### CROSS-REFERENCE TO RELATED APPLICATION

This is a non-provisional US patent application claiming priority under 35 U.S.C. § 119(e) to U.S. Provisional Patent Application No. 63/314,792 filed on Feb. 28, 2022.

### TECHNICAL FIELD

The present disclosure generally relates to energy storage modules, and more particularly, to support structures for battery power packs.

### BACKGROUND

Uninterruptible power supplies, or battery backup systems, provide power to a system even when the regular power source fails. In such instances, rechargeable energy storage cells are often used as an uninterruptible power supply in data centers, telecommunication systems, utility plants, solar applications, power grids and many other applications. Lithium-ion batteries are one example of an effective uninterruptible power supply because they can be scaled in power to meet the needs of the specific application.

For example, individual Lithium-ion batteries may be electronically coupled together to form a pack, and multiple packs may be electronically coupled together in stacks, or trays, for example, to meet the voltage or power needs of the specific application. Typically, however, support structures for these battery packs are capacity specific (i.e. not scalable) and are not easy to disassemble. As, such there is a need for support structures that may be easily disassembled and reassembled for repair, maintenance, remanufacture, repurpose and/or rearrangement.

### SUMMARY

In accordance with one aspect of the present disclosure, a power pack module is disclosed. The power pack module may include a power core, a shell encasing the power core, and a weld plate. The power core may include a plurality of energy cells. The shell may be formed from a pair of interlocking half-shell members, and the weld plate may be affixed to the shell.

In accordance with another aspect of the present disclosure, a power pack module is disclosed. The power pack module may include a power core with a plurality of energy cells, a shell encasing the power core, a weld plate, a busbar plate and a cover. The shell may be formed from a pair of interlocking half-shell members. The weld plate may be affixed to each of the plurality of energy cells through at least one aperture in the shell. The busbar plate may be affixed to the weld plate, and the cover may be affixed to the shell, thereby enclosing the weld plate and the busbar plate.

In accordance with yet another aspect of the present disclosure, a method of constructing and arranging a plurality of power pack modules is disclosed. The method may include assembling a power core by disposing a plurality of energy cells into a support structure having a plurality of channels. Each channel may be dimensioned to receive one energy cell. The method may further include encasing the power core in a shell. A weld plate may be coupled to the power core by welding a plurality of regions of the weld plate to each of the energy cells through a plurality of apertures in the shell. The power core, the shell and the weld plate may constitute one of the plurality of power pack modules. Further, the method may include abutting the plurality of power pack modules in one of a vertical or horizontal direction; and affixing a circuit board to one of the plurality of power pack modules such that the plurality of power pack modules are electronically connected.

These and other aspects and features of the present disclosure will be better understood upon reading the following detailed description, when taken in conjunction with the accompanying drawings.

### BRIEF DESCRIPTION OF THE DRAWINGS

FIG. 1 is an elevated perspective view of an exemplary power core for a power pack module according to an embodiment of the present disclosure;

FIG. 2 is a top view of an exemplary support structure for a power core according to an embodiment of the present disclosure;

FIG. 3 is an elevated perspective view of an exemplary shell for a power pack module according to an embodiment of the present disclosure;

FIG. 4 is an elevated perspective view of an exemplary shell for a power pack module according to an embodiment of the present disclosure;

FIG. 5 is an enlarged view of a portion of an exemplary shell for a power pack module according to an embodiment of the present disclosure;

FIG. 6 is an exploded perspective view of a power pack module with a cover according to an embodiment of the present disclosure;

FIG. 7 is an exploded perspective view of a power pack module with a cover according to an embodiment of the present disclosure;

FIG. 8 is an elevated perspective view of a weld plate of a power pack module according to an embodiment of the present disclosure;

FIG. 9 is an enlarged view of a portion of an exemplary weld plate of a power pack module according to an embodiment of the present disclosure;

FIG. 10 is an elevated perspective view of a power pack module according to an embodiment of the present disclosure;

FIG. 11 is an elevated perspective view of a power pack module according to an embodiment of the present disclosure;

FIG. 12 is an elevated perspective view of a power pack module with a cover according to an embodiment of the present disclosure;

FIG. 13 is an elevated perspective view of an exemplary cover for a power pack module according to an embodiment of the present disclosure;

FIG. 14 is a top perspective view of power pack modules arranged in a stack according to an embodiment of the present disclosure;

FIG. 15 is an cross-sectional view of the stacked power pack module of FIG. 9, according to an embodiment of the present disclosure;

FIG. 16 is a top perspective view of power pack modules arranged in a trayed formation according to an embodiment of the present disclosure;

FIG. 17 is a top perspective view of a power pack module according to an embodiment of the present disclosure;

FIG. 18 is a top perspective view of power pack modules arranged in a trayed formation according to an embodiment of the present disclosure;

FIG. 19 is a top perspective view of power pack modules arranged in a trayed formation according to an embodiment of the present disclosure;

FIG. 20 is an elevated perspective view of an exemplary power core for a power pack module according to an embodiment of the present disclosure;

FIG. 21 is a top view of an exemplary support structure for a power core according to an embodiment of the present disclosure;

FIG. 22 is an enlarged view of a portion of an exemplary support structure for a power core according to an embodiment of the present disclosure;

FIG. 23 is an exploded perspective view of a power pack module according to an embodiment of the present disclosure;

FIG. 24 is an exploded perspective view of a power pack module according to an embodiment of the present disclosure;

FIG. 25 is an elevated perspective view of a power pack module according to an embodiment of the present disclosure;

FIG. 26 is a top perspective view of power pack modules arranged in a cubed formation according to an embodiment of the present disclosure;

FIG. 27 is an exemplary flowchart describing a method for assembling and arranging power pack modules, according to an embodiment of the present disclosure;

FIG. 28 is an exemplary flowchart describing a method for assembling and arranging power pack modules, according to an embodiment of the present disclosure; and

FIG. 29 is an exemplary flowchart describing a method for assembling and arranging power pack modules, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

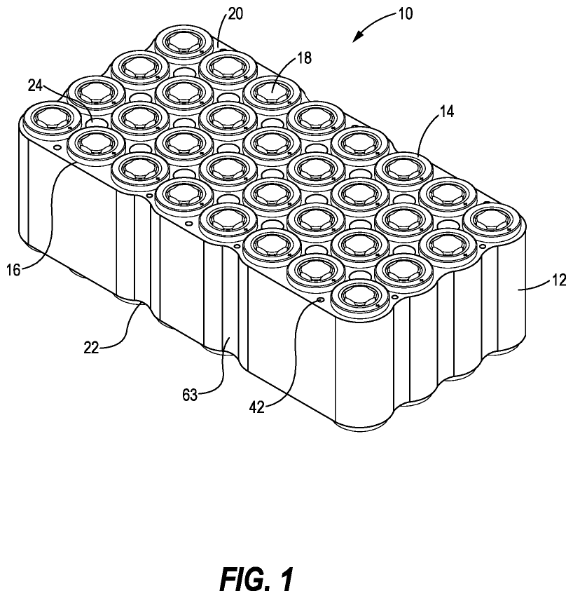

FIG. 1 illustrates an elevated perspective view of a power core 10, according to an embodiment of the present invention. The exemplary power core 10, as illustrated, may include a support structure 12 to house a plurality of interconnected or interconnectable energy storage cells 14, disposed adjacent each other. In the illustrated embodiment, thirty-two cells 14 are arranged in an 8×4 in-line grid; however, other arrangements may be suitable depending on the application and the required power, available storage space, or the like. The illustrated cells 14 may be rechargeable, and may be battery cells, superconductor capacitor cells, or other similar energy storage cells. Types of battery cells may include, for example, lithium-ion, lithium sulfur, zinc nickel, aluminum graphite or solid state. As will be discussed further below, multiple power cores 10 may be electronically coupled together and stored in racks, cabinets, frames, trays, jars or other containers, depending on the application and available storage space, among other parameters.

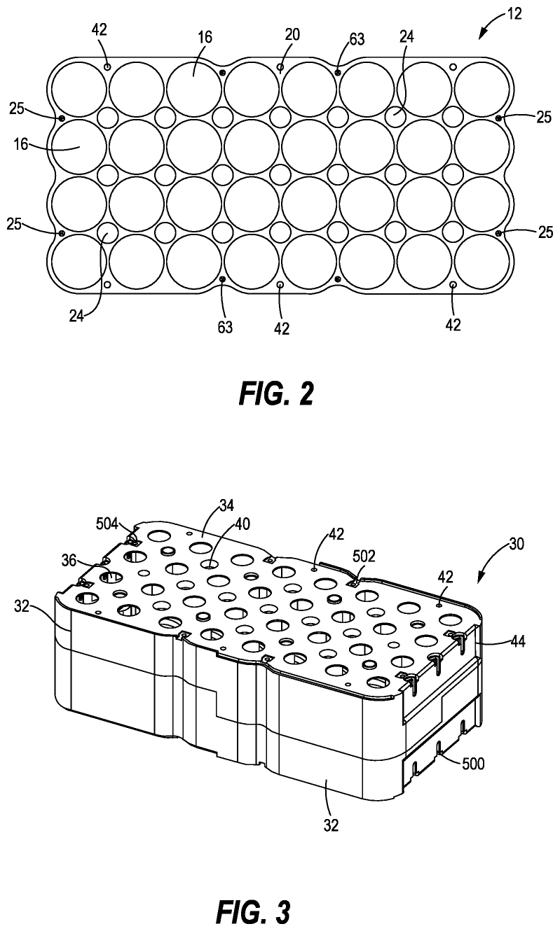

FIG. 2 illustrates a top view of the support structure 12, according to an embodiment of the present invention. The support structure 12 may be solid or hollow, and formed from a plastic material such as a fire retardant plastic or a thermoplastic polymer (e.g. polypropylene) or polyester (e.g. polylactide), a metal (e.g. aluminum) or any other material capable of providing both structural support and heat absorption. Alternatively, the support structure may also be formed from a phase change material capable of storing and releasing thermal energy. Phase change materials may include substances that may change phases (e.g. from solid to liquid and vice versa, from one conformity of crystallization to another, etc.) at certain trigger temperatures. For example, in a cold environmental application, the phase change material may insulate heat within the support structure 12; conversely, in a warm environmental application, the phase change material may discharge or dissipate heat to cool the cells 14. While the illustrated support structure 12 is a single, solid structure, in alternative embodiments, the support structure may be formed from a plurality of separator walls interlocked together to form the support structure.

The support structure 12 may include a plurality of channels 16, each dimensioned to accommodate one cell 14 (FIG. 1). The channels 16 may be cylindrical and open at both a top side 20 and a bottom side 22 of the support structure, enabling exposure of the cell terminal 18 of each cell 14 to electronic connections. The support structure 12 may further include a plurality of conduits 24 that, like the channels 16, extend through the support structure from the top side 20 to the bottom side 22. Finally, a plurality of fastener apertures 25, 42 may extend through the support structure from the top side 20 to the bottom side 22. Each fastener aperture 25, 42 may be configured to accept a fastener, such as a dowel, screw or bolt. In the illustrated embodiment, fastener apertures 25 may be positioned at opposite edges of the support structure 12, while fastener apertures 42 may be positioned at opposing edges of the support structure perpendicular to fastener apertures 25.

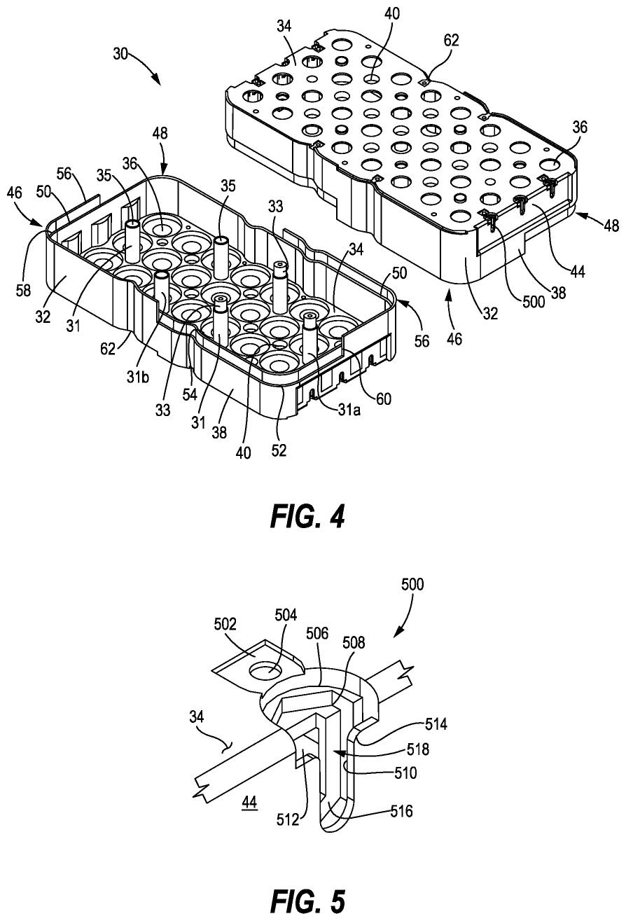

Referring now to FIGS. 3 and 4, with continued reference to FIGS. 1 and 2, a shell 30 to house, for example, power core 10 is illustrated. The shell 30 may be formed from a pair of congruent half-shell structures 32. As illustrated in FIG. 4, each half-shell 32 may be rotationally symmetrical, such that two half-shell pieces may interlock to form the shell 30. The half-shell 32 may be plastic or metal formed via injection molding, although other materials and methods are contemplated. The half-shell 32 is generally rectangular in shape with a base plate 34 and a plurality of side walls 38. The base plate 34 may include a plurality of circular cell apertures 36, with each cell aperture corresponding to one of the cells 14 in the power core 10. Each cell aperture 36 may accordingly be dimensioned to retain the corresponding cell 14. The base plate 34 may further include a plurality of conduit apertures 40 that may be dimensioned and aligned with the conduits 24 extending through the support structure 12. While the support structure 12, as illustrated in FIG. 2, includes as many as twenty-one conduits 24, the base plate 34 may include the same or fewer conduit apertures 40, depending on the application. Opposing side walls 38 may include one or more troughs 62 that may correspond to troughs 63 (FIG. 2) in the support structure 12, which may assist with restriction of movement of the support structure within the shell 30.

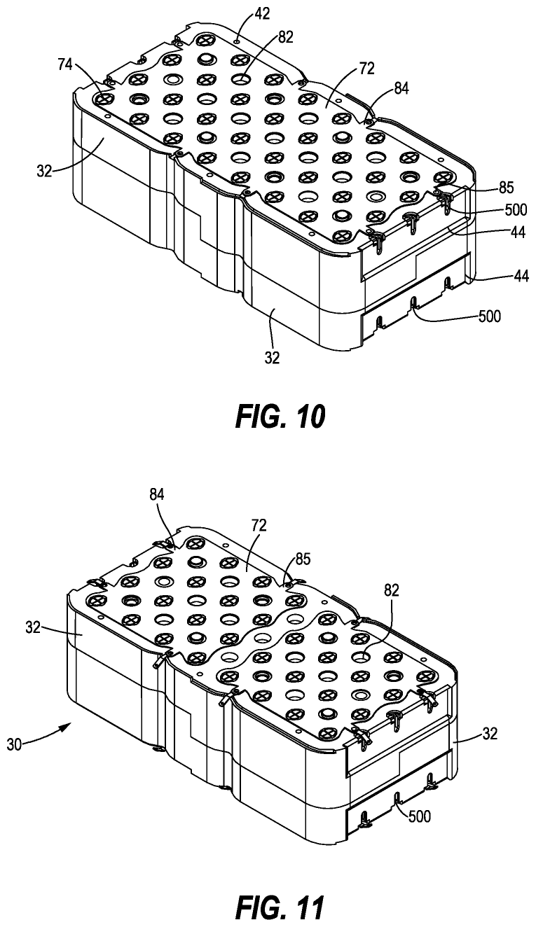

Opposing side walls 38 may also include a recess 44, dimensioned to accommodate a busbar plate tab 112, which will be discussed in further detail with respect to at least FIGS. 10-12. As illustrated in FIG. 5, the recess 44 may include a plurality of attachment regions 500 including at least a tab recess 502 with an aperture 504. The tab recess 502 and aperture 504 may also be positioned at a plurality of locations around an outer edge of the base plate 34. Each aperture 504 may correspond to, and align with, one of the fastener apertures 25 of the support structure 12, such that a fastener may be inserted through both the aperture 504 and the corresponding fastener aperture 25 to secure the support structure within the shell 30, for example. The attachment region 500 may further include a counterbore 506 with a polygonal recess 508 dimensioned to accept fasteners, such as for example, a hexagon head nut with lock washer (not shown). The attachment region 500 may also include a slot 510 formed between an external wall 514 and an internal wall 516 of the side wall 38. A generally U-shaped opening 518 may be formed in the external wall 514 and a corresponding opening 512 may be formed in the internal wall 516. In this arrangement, a body of the nut with lock washer, for example, may slide into, and be retained by, the slot 510, while an opposite end of the fastener may, for example, extend through the U-shaped opening 518 or the opening 512 in the internal wall 516 in order to retain various components of the assembly.

With continued reference to FIGS. 3 and 4, to facilitate the assembly of the shell 30 from a pair of half-shell structures 32, the half-shell includes complementary side wall structures, configured to slide against each other and thereby interlock when assembled. More specifically, the half-shell 32 may include two high wall regions 46 and two low wall regions 48. The pair of high wall regions 46 may be arranged diagonally opposite each other, and similarly, the pair of low wall regions 48 may be arranged diagonally opposite each other. As illustrated in FIG. 4, the two high wall regions 46 and two low wall regions 48 may each extend across adjacent side walls 38; however, in alternative embodiments, one high wall region and one low wall region may be formed, or more than two high wall regions and more than two low wall regions may be formed. The high wall region 46 may be distinguishable from the low wall region 48 by the fact that the height of the side wall 38 within the high wall region may be higher than that of the side wall in the low wall region. The high wall region 46 may include an internal ledge 50 that extends the length of the high wall region and defines an internal recess 58. Similarly, the low wall region 48 may include an external ledge 52 that extends the length of the low wall region and defines an external recess 60.

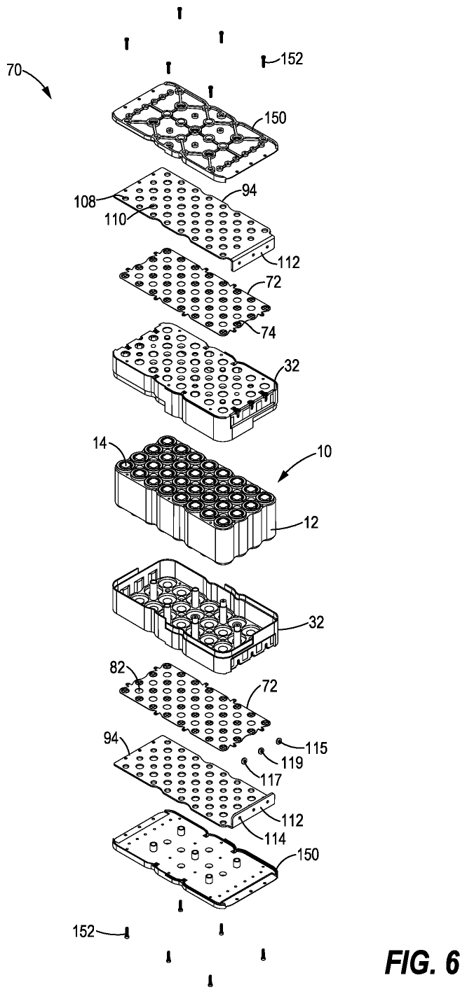

The height of the external recess 60 may correspond to a distance between the external ledge 52 and a top 54 of the low wall region 48. Similarly, the height of the internal recess 58 may correspond to the distance between the internal ledge 50 and a top 56 of the high wall region 46. Furthermore, the height of the external recess 60 and the height of the internal recess 58 may be the same, such that during assembly of the shell 30, the two half-shells 32 may fit together such that no gap exists between the two half-shells (see e.g. FIG. 6). However, as will be described in further detail below, the half-shells 32 are configured to be telescoping, such that a gap may exist between the half-shells depending on the height of the contents of the shell 30.

Finally, each half-shell 32 may include a plurality of cylindrical posts 31 extending from an internal surface of the base plate 34. At least a portion of the posts 31 may be configured to matingly engage the remaining posts when the two half-shell 32 pieces are fitted together. More specifically, a portion of the posts 31a may have a region of reduced diameter 33, while a portion of the posts 31b may have an internal bore 35 dimensioned to accommodate the region of reduced diameter when the shell 30 is assembled.

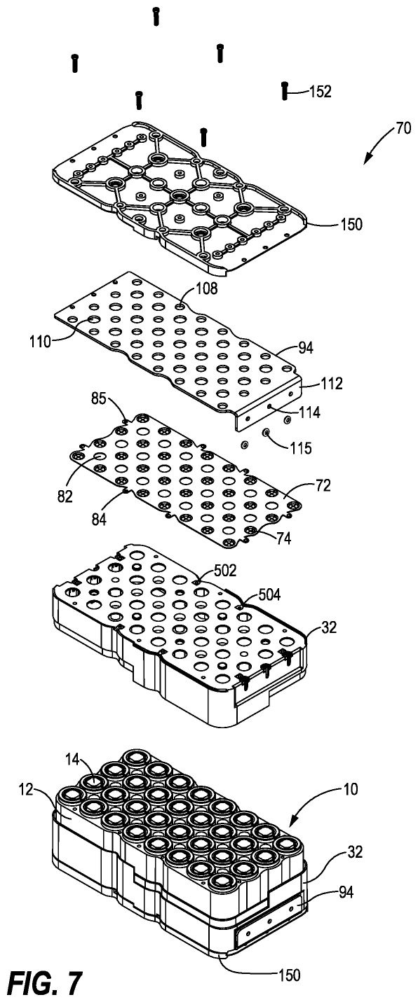

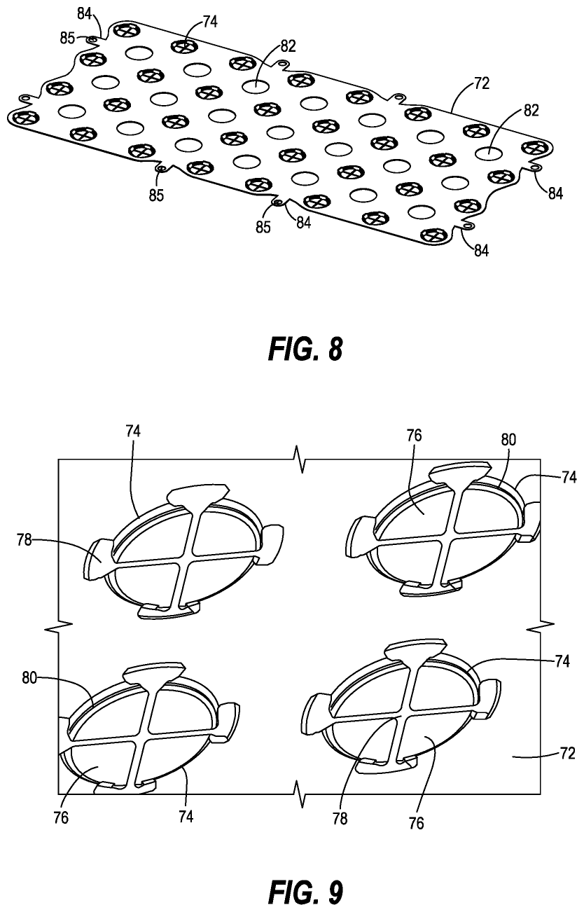

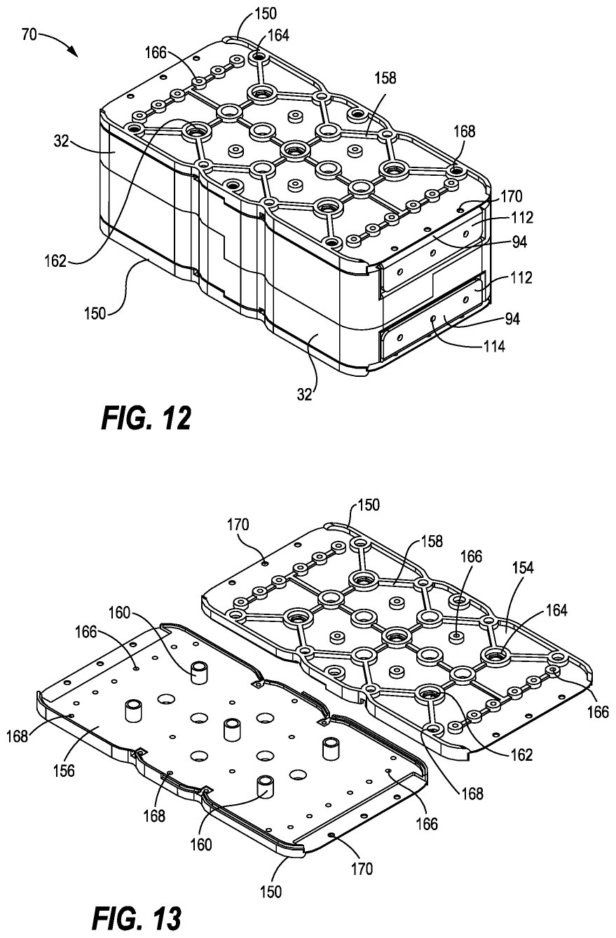

Referring now to FIGS. 6-13, an exploded view of a power pack module 70 (FIGS. 6-7), as well as an assembled power pack module (FIG. 12) are illustrated. The power pack module 70 may include the power core 10 enclosed within the shell 30 formed from two half-shells 32, and may further include at least one weld plate 72. In one embodiment, the power pack module 70 includes a pair of weld plates 72, however, alternative arrangements are also contemplated. Each weld plate 72 may be made of metal, and may include a plurality of circular depressions 74, which are illustrated in detail in FIG. 9. More specifically, the weld plate 72 may be made of nickel or other metal or alloy, and may in some embodiments be 95% pure nickel or greater. The number of depressions 74 may correspond to both the number of cell apertures 36 and cells 14. Each depression 74 may generally have an embossed contour and include a plurality of projecting tabs 76 defined by a cross-shaped opening 78 in the weld plate 72. Each projecting tab 76 may have a chamfered connection 80 to the weld plate 72. In this arrangement, the depth of each depression 74 may ensure contact between the projecting tabs 76 and the cell terminal 18 of each cell 14. Such contact, as described, may be made by welding using, for example, resistance, laser or ultrasonic welder, depending upon the application and its specific requirements. Fusing, such as one or more nickel fusing strips, may also be used. As illustrated, each depression 74 may include four projecting tabs 76, although fewer or more projections may be formed by changing the shape of the opening 78.

The weld plate 72 may further include a plurality of conduit apertures 82 that may align with one of the conduit apertures 40 in each half-shell 32 and, ultimately, the conduits 24 in the support structure 12. Each weld plate 72 may optionally include at least one tab 84 having an aperture 85. Each tab 84 may align with, and be dimensioned to fit within, one of the plurality of tab recesses 502 on the half-shell 32. Similarly, each aperture 85 of each tab 84 may align with the aperture 504 in the tab recess 502. In one embodiment, as illustrated in FIG. 6, for example, a pair of weld plates 72 may be employed, one on each side of the shell 30. In this arrangement, one weld plate 72 may carry a positive charge, while the second weld plate may carry a negative charge. In an alternative embodiment, as illustrated in FIG. 11, for example, four weld plates 72 may be employed, with a pair of weld plates positioned on each side of the shell 30. In this arrangement, the pair of weld plates 72 positioned on one side of the shell 30 may carry opposite charges.

The power pack module 70 may further include at least one busbar plate 94. In the embodiment illustrated in FIG. 6, the power pack module 70 may include a pair of busbar plates 94. Each busbar plate 94 may be made of metal, such as copper, for example, and each may include a plurality of apertures 108 that may correspond to both the number and position of the cell apertures 36 and the cells 14. Each busbar plate 94 may further include a plurality of conduit apertures 110 that may correspond in both number and position to one or more of the conduit apertures 40 in each half-shell 32 and, ultimately, the conduits 24 in the support structure 12. Finally, each busbar plate 94 may include a tab 112, which may be configured with fit within the recess 44 in the side wall 38 of each half-shell 32. The tab may include a plurality of apertures 114 that may align with the plurality of attachment regions 500.

In this arrangement, fasteners 115 may be used to secure the busbar plate 94 to the shell 30 or other external busbar components not shown. The fasteners 115, for example, may include a head portion 117 and a post portion 119. In this arrangement, the post portion 119 may be inserted through the aperture 114 from the interior toward the exterior of the power pack module, and the head portion 117 may subsequently slide into the slot 510 of the attachment region 500. While only one set of fasteners 115 is illustrated in FIG. 6, a second set of fasteners 115 may be used to secure the second busbar plate 94 to the shell 30 as well.

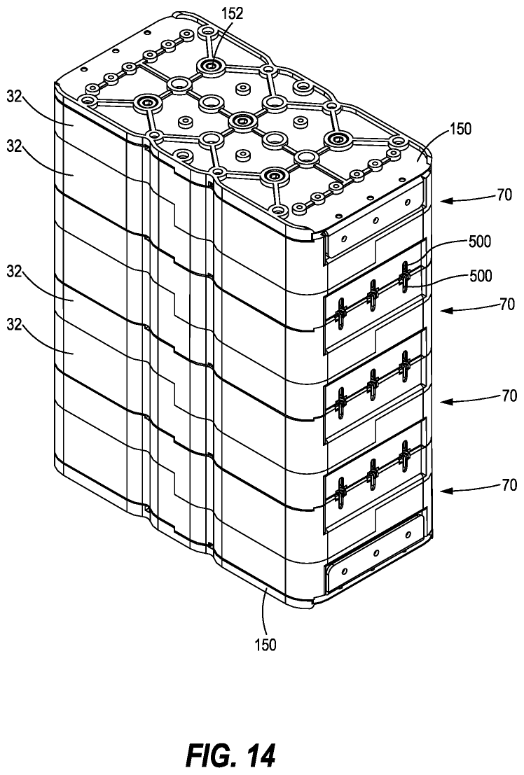

Finally, the power pack module 70 may include a cover 150, shown in detail in FIGS. 12 and 13. The cover 150 may be positioned on opposite ends of the power pack module 70, as illustrated in FIG. 6 for example, or, on opposite ends of a stack of power pack modules, as illustrated in FIG. 14. Each cover 150 may be fixedly attached to the shell 30 via a plurality of fasteners 152, thereby securing components of the power pack module 70 together. The cover 150 may include an external side 154 and an opposite internal side 156. The external side 154 may include a series of structural ribs 158 that may provide strength to the cover 150. The internal side 156 may include a plurality of threaded posts or knobs 160. Each knob 160 may align with one of the conduits 24 in the power core 10, and may be dimensioned to at least partially engage said corresponding conduit. The knobs 160 may be threaded internally to accept a screw, bolt or other fastener that may be inserted from the external surface 154 through an aperture 162 with a hexagonal counterbore 164.

The cover 150 may further include a plurality of apertures 166 arranged linearly proximate to both ends of the cover 150. In some embodiments, one or more fasteners, such as screws, may be inserted through one or more of the apertures 166 to secure other components (such as, for example, a circuit board 172) of the power pack module 70 to the cover 150. In a similar manner, the cover 150 may include a plurality of apertures 168 that may be arranged to align with fastener apertures 42 in the support structure 12 and half-shell 32, such that a fastener may be inserted through all components of the power pack module 70 while also securing the cover 150. Finally, the cover 150 may include a plurality of bus fastener apertures 170 that may align with the attachment regions 500 and at least one tab aperture 84. In this arrangement fasteners, such as screws for example, may be inserted through the bus fastener apertures 170, through the busbar plate 94, the weld plate 72 and into the shell 30 to secure these components together.

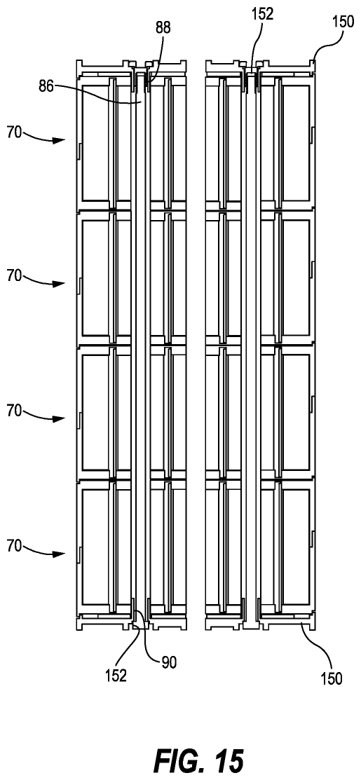

Referring now to FIGS. 14 and 15, in certain applications, the power pack modules 70 may be arranged in a stack formation. In the illustrated embodiment, power pack modules 70 may be connected in series, and thus arranged such that weld plates 72 in contact with each other may carry opposite charges (i.e. positive and negative). In the stacked arrangement illustrated in FIG. 14, each of power core 10 may be installed within a pair of half-shells 32, and a pair of weld plates 72 may be welded to each side of the shell 30 (see FIGS. 10 and 11). The units are stacked, such that the weld plates 72 are in direct contact with each other. Once stacked, a pair of busbar plates 94 may be added to the top and bottom of the stack, as well as a pair of covers 150. While the illustrated embodiment provides a stacked arrangement with four power pack modules 70, any number of power pack modules may be stacked together depending on the application needs. To stabilize the stack, and to promote conductivity between the power pack modules 70, at least one rod 86 may be inserted through the stack to improve stability and reduce vibration between the power pack modules 70. The rod 86 may made of metal or other rigid material, and may be threaded at each end 88 to facilitate attachment of a nut 90.

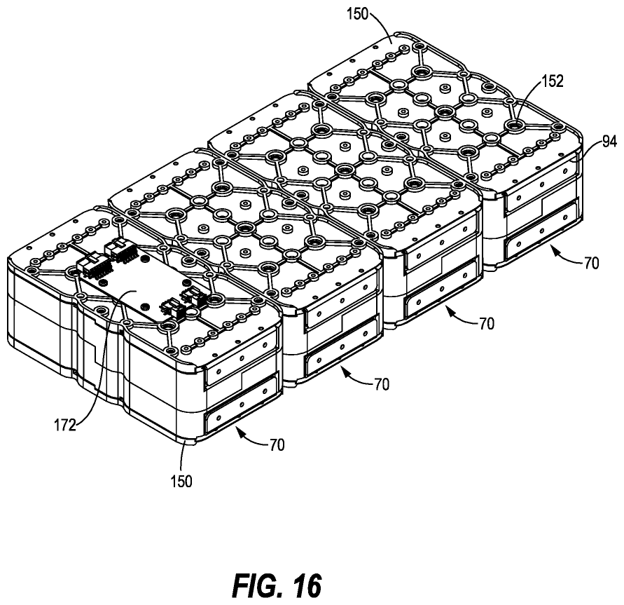

In an alternative embodiment, as illustrated in FIGS. 16-19, the components of the power pack module 70 may be formed and arranged to facilitate linear or trayed configurations, as opposed to a stacked configuration. Whether stacked or trayed, the power pack modules 70 may also include one or more circuit boards 172 configured to facilitate measurement and monitoring of the temperature and voltage of each power pack module, as well as to utilize balancing circuitry. If, for example, in the illustrated embodiment of FIG. 15 or FIG. 16, the voltage of a first power pack module 70 rises above or drops lower than the voltage of the second, third, and fourth power pack modules, the balancing circuitry in the second, third, and fourth power pack modules may react to this rise or drop and adjust the resistance and/or current until balanced across all four power pack modules.

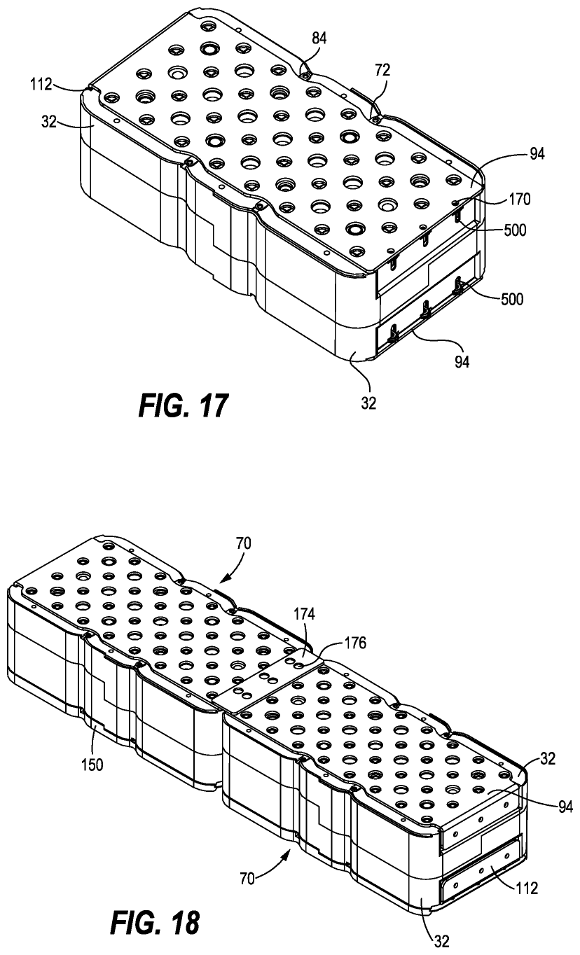

With specific reference to FIGS. 17-19, in one embodiment, the power pack modules 70 may be arranged in a linear or trayed configuration by abutting two power pack modules at their respective attachment regions 500. As illustrated in FIG. 17, the power core 10 may be installed within the shell 30, and a pair of weld plates 72 may be positioned in contact with the base plates 34 of each half-shell 32. Each weld plate 72 may be welded to the power core 10. A busbar plate 94 may be fixedly attached to each weld plate 72, such as by welding. The busbar plate tabs 112 may be arranged on the same side of the shell 30.

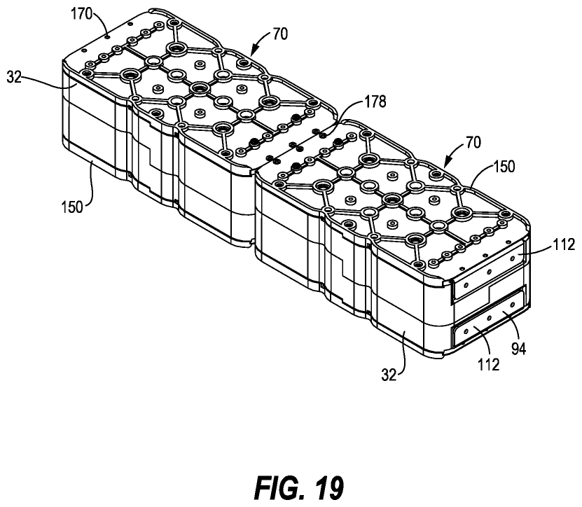

As illustrated in FIG. 18, to join the two power pack modules 70 at their respective attachment regions 500, they may be butted together, such that the busbar plate tabs 112 may be positioned opposite the joining region, as shown. A joining plate 174 may be positioned across the power pack modules, and may include a plurality of attachment apertures 176 that may align with the bus fastener apertures 170 of each busbar plate 94. In this arrangement, as shown in FIG. 19, the covers 150 may be fixed to both sides by installing a plurality of fasteners 178, such a screws, in the attachment apertures 176. In this manner, each fastener 178 may extend from the exterior surface of the power pack module 70, through one of the attachment apertures 176, through one of the bus fastener apertures 170, and into the attachment region 500.

As noted above, the half-shells 32 are configured to be telescoping, such that a gap (not shown) may exist between the half-shells, depending on the height of the contents of the shell 30. The height of the contents of the shell 30 may vary because the thickness of each weld plate 72 or busbar plate 94 may be variable depending on the amount of power required in a specific application. For example, if the weld plate 72 or busbar plate 94 were 0.25″ thick, it could offer a higher current carrying capacity than, for example, if the weld or busbar plate were manufactured to be only 0.1″ thick.

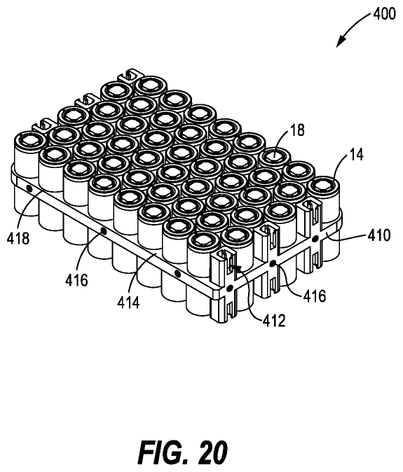

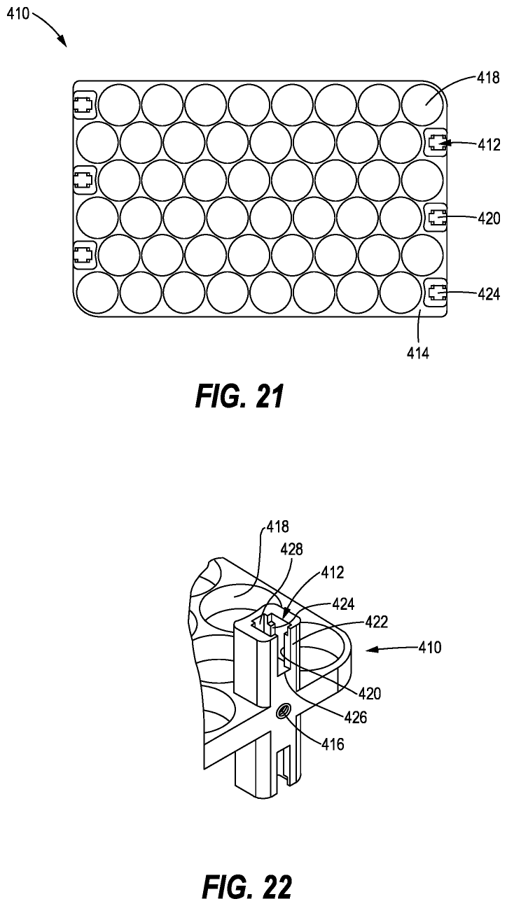

In an alternative embodiment, illustrated in FIGS. 20-26, a staggered power core 400 may include forty-eight energy storage cells 14 arranged in a staggered grid format. As illustrated, for example, the grid format may be an 8×6 staggered grid. The power core 400 may include a support structure 410 to house the plurality of energy storage cells 14. The support structure 410 main include a main body 414 and a plurality of attachment regions 412. The main body 414 may include a plurality of channels 418, each dimensioned to accommodate one cell 14. The channels 416 may be cylindrical and extend through the main body 414 of the support structure 410, enabling exposure of the cell terminal 18 of each cell 14 to electronic connections. Notably, the alternative embodiment of the support structure 410 illustrated in FIGS. 20-26 omits the fastener apertures 25, 42 and the conduits 24 utilized by support structure 12. The main body 414 may include a plurality of fastener apertures 416 positioned along an exterior surface. Each fastener aperture 416 may be configured to accept a fastener, such as a screw or bolt. For example, each fastener aperture 416 may be threaded.

As illustrated in FIG. 22 specifically, the attachment regions 412 may be positioned at a plurality of locations at the periphery of the main body 414. As illustrated, the support structure 410 includes six attachment regions—three on each of two opposing edges. However, other arrangements are also contemplated. Each attachment region 412 may include a polygonal recess 428 dimensioned to accept fasteners, such as for example, a hexagon head nut with lock washer (not shown). The recess 428 may be square, although other shapes are also contemplated. The attachment region 412 may further include a slot 420 defined by a plurality of side walls 422, a plurality of ledges 424 and a generally U-shaped opening 426 formed in one of the side walls. In this arrangement, a head of a fastener, for example, may slide into, and be retained by, the slot 420, while a body of the fastener may, for example, extend through the U-shaped opening 426 in order to retain various components of the assembly. Similarly, in this arrangement, a fastener with a polygonal shaped head, for example, may be inserted into the polygonal recess 428 and seated on the plurality of ledges 424. In the latter arrangement, the fastener with a polygonal shaped head my be restricted in rotational movement by the contact and fit within the plurality of side walls 422.

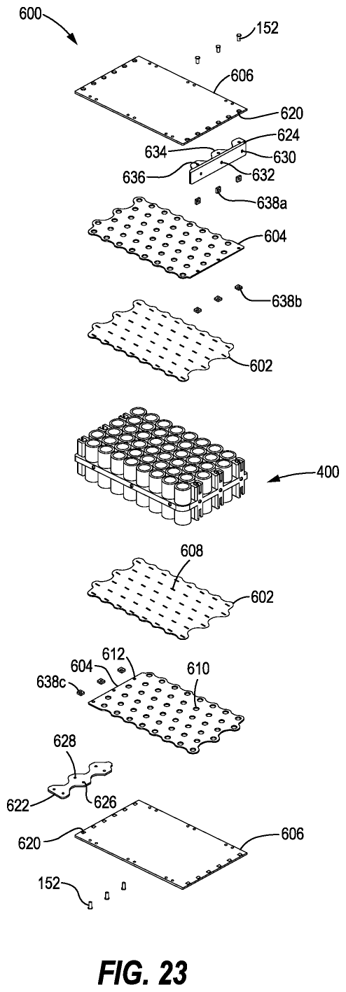

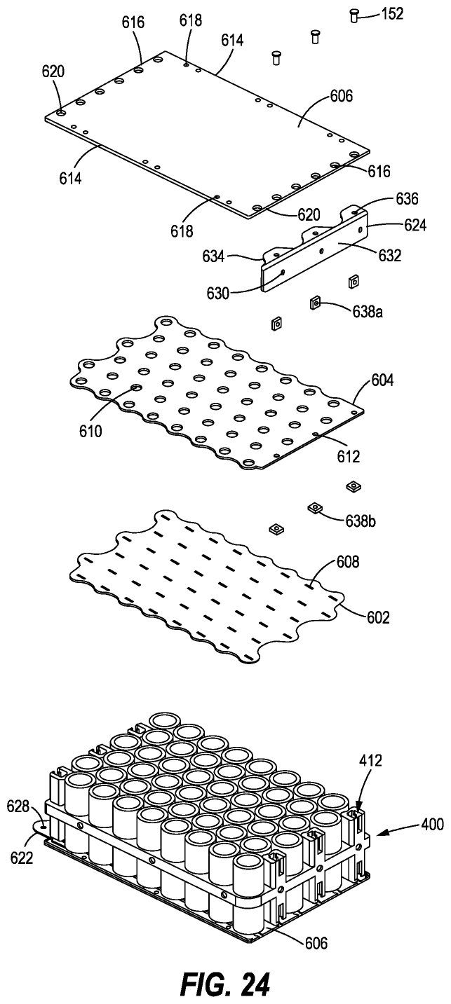

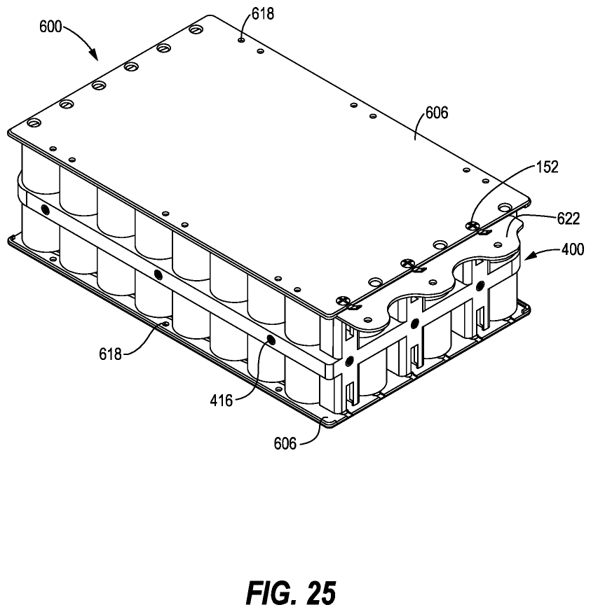

Referring now to FIGS. 23-25, an exploded view of a power pack module 600 (FIGS. 23 and 24), as well as an assembled power pack module (FIG. 25) are illustrated. The power pack module 600 may include the power core 400, a pair of weld plates 602 and a pair of busbar plates 604. Each weld plate 602 may be made of metal, and may include a plurality of oblong apertures 608. More specifically, the weld plate 602 may be made of nickel or other metal or alloy, and may in some embodiments be 95% pure nickel or greater. The number of oblong apertures 608 may correspond to both the number of cells 14 as well as a number of cell apertures 610 in each busbar plate 604. Furthermore, each busbar plate 604 may be made of metal, such as copper, for example, and each may include a plurality of apertures 610 that may correspond to the number and position of cells 14, as well as the number and position of oblong apertures 608 of the weld plate 602. Finally, each busbar plate 604 may include a plurality of apertures 612 positioned along an edge of the busbar plate, and dimensioned to receive fasteners 152 during assembly of the power pack module 600.

The power pack module 600 may include a pair of covers 606. The covers 606 may be positioned on opposite ends of the power pack module 600, and each cover 606 may be fixedly attached to the shell 30 via a plurality of fasteners 152, thereby securing components of the power pack module 600 together. Each cover 606 may be generally rectangular in shape, and dimensioned to match the area of the power core 400, and the remaining components of the power pack module 600. In that regard, each cover 606 may have a pair of long sides 614 and a pair of short sides 616. A first plurality of fastener apertures 618 may be arranged along the edge of each long side 614 of the cover 606, and a second plurality of fastener apertures 620 may be arranged along the edge of each short side 616 of the cover. In some embodiments, one or more fasteners 152, such as screws, may be inserted through one or more fastener apertures 620 to secure the cover 606 to the other components of the power pack module 600. The first plurality of apertures 618 may have a smaller diameter than the second plurality of apertures 620, as the first and second plurality of apertures may utilize different styles and sizes of fasteners, for example, as will be explained in further detail below.

A joining plate 622 and a joining bracket 624 may be used to aid in securing the individual components of the power pack module 600 together. The joining plate 622 may be positioned between one of the busbar plates 604 and the corresponding cover 606, and may include a plurality of interior fastener apertures 626 and a plurality of exterior fastener apertures 628. The interior fastener apertures 626 may be positioned to align with the busbar plate 604 apertures 612 and the attachment regions 412. The joining bracket 624 may be positioned at an opposite end of the power pack module 600 from the joining plate 622, between the busbar plate 604 and the cover 606. The joining bracket 624 may include a plurality of bracket apertures 630 arranged along a main body plate 632, and configured to align with each of the attachment regions 412. The joining bracket 624 may further include a set of bracket tabs 634 extending inwardly and at an approximate 90 degree angle to the main body plate 632. Each bracket tab 634 may include a fastener aperture 636 that may be configured to receive fastener 152, and my consequently align with one of the fastener apertures 620 of the cover 606, one the apertures 612 of the busbar plate 604, and one of the attachment regions 412.

In the illustrated arrangement, fasteners 152 may be used in conjunction with nuts 638 to secure the components of the power pack module 600. The nuts may be generally square, and dimensioned to fit within the slot 420 and recess 428 of the attachment regions 412. For example, as illustrated in FIGS. 23 and 24, each nut 638a may be arranged vertically to slide into one of the slots 420 of one of the attachment regions 412. In this arrangement, a fastener (not shown) may be inserted through one of the bracket apertures 630 of the joining bracket 624, through the corresponding U-shaped opening 426, and finally through the nut 638a in the slot 420. Nuts 638b may be arranged horizontally to seat within the recess 428 of the attachment region 412 after nut 638a has been inserted into the slot 420. In this arrangement, one of the fasteners 152 may be inserted through one of the fastener apertures 620 of the cover 606, through one of the fastener apertures 636 of the bracket tab 634, through one of the apertures 612 of the busbar plate 604, and finally through one of the nuts 638b seated in the recess 428 of the attachment region. Similarly, nuts 638c may also be arranged horizontally to seat within the recess 428 of the corresponding arrangement region. In this arrangement, one of the fasteners 152 may be inserted through one of the fastener apertures 620 of the cover 606, through one of the interior fastener apertures 626 of the joining plate 622, through one of the apertures 612 of the busbar plate 604, and finally through one of the nuts 638c seated in the recess 428 of the corresponding attachment region.

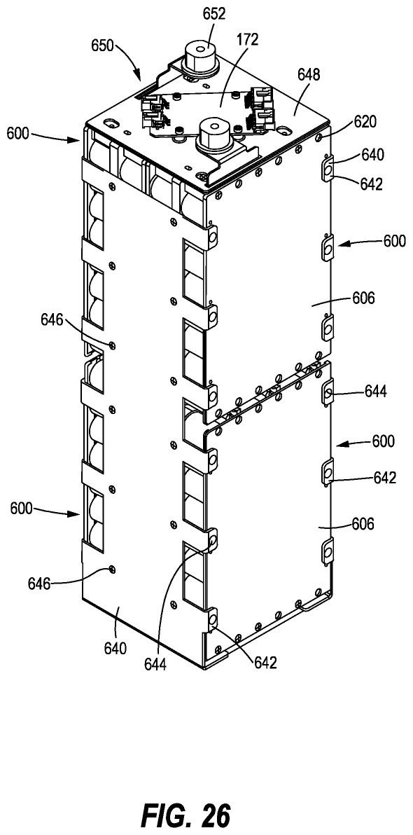

Referring now to FIG. 26, in certain applications, multiple power pack modules 600 may be coupled together and arranged in, for example, trayed, cubed or stacked formations. In the illustrated embodiment, four power pack modules 600 are arranged in a cube configuration. In such an arrangement, a pair of support plates 640 may be used to hold the power pack modules in the cube configuration. The support plate 640 may be metal, such as aluminum, although other materials are also contemplated. Each support plate 640 includes a plurality of tabs 642 configured to align with the fastener apertures 618 of each cover 606. During assembly, each support plate 640 is fixed to the stacked power pack modules 600 using a first set of fasteners 644 inserted through the tabs 642 of the support plate 640 and through the fastener apertures 618 of the cover 606, and using a second set of fasteners 646 inserted through the support plate and into the fastener apertures 416 positioned along an exterior surface of the main body 414 of the support structure 410. Once the cube of power pack modules 600 is secured by the support plates 640, an insulator end cap 648 may be fastened to a top end 650 or to a bottom end of the cube. A pair of terminals 652 may also be installed in the end cap 648, as well as a circuit board 172.

### INDUSTRIAL APPLICABILITY

The disclosed sustainable power pack modules may be applied in a wide variety of energy applications. While the exemplary embodiments of the sustainable power pack modules are illustrated in stacked and trayed orientations, it will be understood that inventive aspects of the sustainable power pack modules may be used in energy applications requiring alternative orientations.

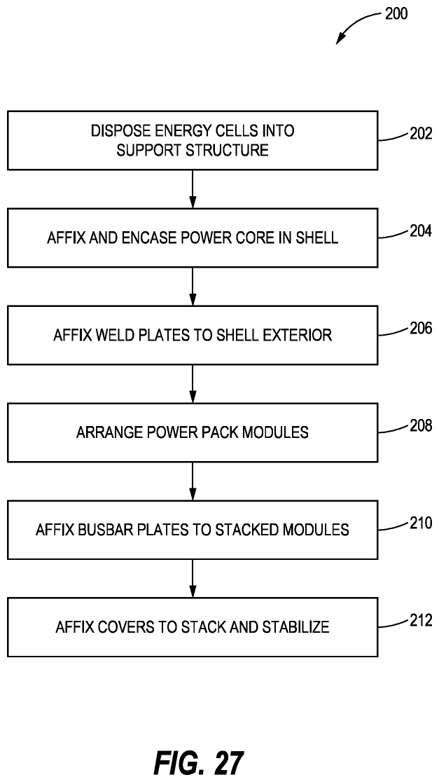

A series of steps 200 for assembling and arranging power pack modules is illustrated in a flowchart format in FIG. 27. Continued reference will also be made to elements illustrated in FIGS. 1-26. In a first step 202, energy storage cells 14 may be disposed, in a one-to-one correspondence, into the channels 16 of the support structure 12, thereby forming the power core 10. Each storage cell 14 may have a positively charged end and a negatively charged end opposite the positively charged end. As such, the orientation of the cell 14 within the channel 16 should be considered. In the illustrated embodiment of FIG. 7, for example, all cells 14 may be oriented in the same direction, such that the weld plate 72 may carry a single charge (e.g. positive or negative). In an alternative embodiment illustrated in FIG. 11, however, it may be desired that one weld plate 72 carry a charge opposite to that of the other shown weld plate. In this arrangement, the storage cells 14 disposed within the shell 30 and contacting one weld plate 72 may be oriented in one direction, while the remaining storage cells that contact another weld plate may be oriented in the opposite direction.

Regardless of the orientation desired, once the cells 14 are disposed in the channels 16 of the support structure 12, the power core 10 may be encased in the shell 30 (step 204). As noted above, the shell 30 may be formed from two identical half-shell structures 32. Once encased, a pair of weld plates 72 may be affixed to the exterior of the shell 30 (step 206). The weld plates 72 may be affixed to the shell 30 via welding, or may simply be press fit in place after one or more of the stabilization rods 86 are installed (see below at step 212).

While a single power pack module 70 may provide enough power for a specific application, in the event a plurality of power pack modules are required, the modules may be arranged to scale power output to meet the application demands. In a step 208, the power pack modules 70 may be stacked and electronically coupled together in series, such that when stacked, weld plates in contact with each other may carry opposite charges. Once stacked, a pair of busbar plates 94 may be affixed to the stack (step 210). Namely, one busbar plate 94 may be affixed to a top of the stack and another busbar plate may be affixed to a bottom of the stack. In one embodiment, the busbar plates 94 may be affixed to the stack by ultrasonic welding, for example.

In a step 212, a pair of covers 150 may be affixed to the stack adjacent the busbar plates 94. The covers 150 may be affixed to the stack, and the stack stabilized via insertion of one or more stabilization rods 86 through the stack. The stabilization rods 86 may be secured at each opposite end 88 via a nut 90. More specifically, each rod 86 may be inserted into and extend through one conduit aperture 82 on each weld plate 72, one conduit aperture 40 in each half-shell 32, and through the conduit 24 of the support structure 12.

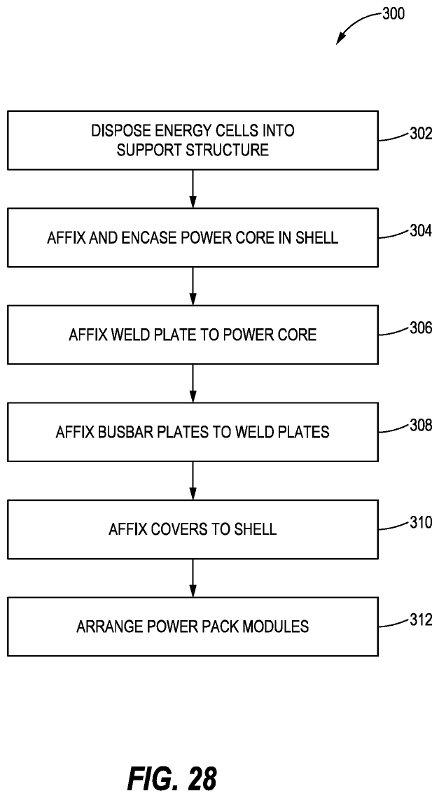

In another embodiment, a series of steps 300 for assembling and arranging power pack modules is illustrated in a flowchart format in FIG. 28. Continued reference will also be made to elements illustrated in FIGS. 1-26. In a first step 302, similar to step 202 described above, energy storage cells 14 may be disposed, in a one-to-one correspondence, into the channels 16 of the support structure 12, thereby forming the power core 10. Each storage cell 14 may have a positively charged end and a negatively charged end opposite the positively charged end. As such, the orientation of the cell 14 within the channel 16 should be considered. In the illustrated embodiment of FIG. 10, for example, all cells 14 may be oriented in the same direction, such that the busbar plate 94 may carry a single charge (e.g. positive or negative).

Once the cells 14 are disposed in the channels 16 of the support structure 12, the power core 10 may be encased in the shell 30 (step 304). Once encased, the weld plate 72 may be affixed to the power core 10 through the shell 30 (step 306). The weld plate 72 may be aligned with the power core 10, such that each depression 74 may align with a cell terminal 18 in a one-to-one correspondence. Once aligned, the projecting tabs 76 may be used to weld the weld plate 72 to the power core 10 through the shell 30.

A pair of busbar plates 94 may then be coupled to each weld plate 72 (step 308), for example, by ultrasonic welding. Finally, a cover 150 may be affixed to the shell 30, thereby encasing the power core 10, the pair of weld plates 72 and the pair of busbar plates 94—thereby forming the power pack module 70 (step 310).

At a final step 312, while a single power pack module 70 may provide enough power for a specific application, in the event a plurality of power pack modules are required, the modules may be arranged to scale power output to meet the application demands. The power pack modules 70 may be arranged linearly, and may be electronically coupled together in parallel or in series depending on the orientation of each power pack module 70. The power pack modules 100 may be placed in a tray or other structure depending on the application. Once arranged, a circuit board 172 may be fixed to at least one cover 150 of one of the power pack modules 70.

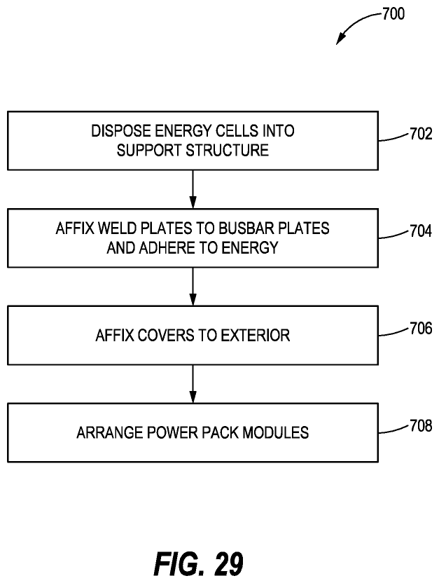

In a further embodiment, a series of steps 700 for assembling and arranging power pack modules is illustrated in a flowchart format in FIG. 29. Continued reference will also be made to elements illustrated in FIGS. 1-26. In a first step 702, similar to steps 202 and 302 described above, energy storage cells 14 may be disposed, in a one-to-one correspondence, into the channels 418 of the support structure 410, thereby forming the power core 400. In a second step 704, one of the weld plates 602 and one of the busbar plates 604 may be joined (e.g. by welding), and each weld plate/busbar plate joint unit may be adhered to the energy cells (step 704). The weld plates 602 may be aligned with the power core 400, such that each oblong aperture 608 may align with a cell terminal 18 in a one-to-one correspondence. A pair of covers 606 may be affixed to the support structure 410 using a plurality of fasteners, encasing the power core 400, the pair of weld plates 602 and the pair of busbar plates 604—thereby forming the power pack module 600 (step 706).

At a final step 708, while a single power pack module 600 may provide enough power for a specific application, in the event a plurality of power pack modules are required, the modules may be arranged to scale power output to meet the application demands. The power pack modules 600 may be arranged in a cube formation, and may be electronically coupled together in parallel or in series depending on the orientation of each power pack module. The power pack modules 600 may be secured together using support plates 640, for example. Once arranged, a circuit board 172 may be fixed to the insulator end cap 648.

While a series of steps and operations have been described herein, those skilled in the art will recognize that these steps and operations may be re-arranged, replaced, eliminated, or performed simultaneously without departing from the spirit and scope of the present disclosure as set forth in the claims.

While aspects of the present disclosure have been particularly shown and described with reference to the embodiments above, it will be understood by those skilled in the art that various additional embodiments may be contemplated by the modification of the disclosed machines, systems and assemblies without departing from the scope of what is disclosed. Such embodiments should be understood to fall within the scope of the present disclosure as determined based upon the claims and any equivalents thereof

What is claimed is:

1. A power pack module, the power pack module comprising:
a power core including a plurality of energy cells;
a shell encasing the power core, the shell formed from a pair of interlocking half-shell members; and
a weld plate affixed to the energy cells through the shell.

2. The power pack module of claim 1, wherein the power core includes a support structure having a plurality of channels, each channel configured to receive one of the plurality of energy cells.

3. The power pack module of claim 2, wherein the support structure includes a plurality of conduits extending through the support structure parallel to the plurality of channels.

4. The power pack module of claim 1, wherein each of the half-shell members in the pair of interlocking half-shell members is structurally identical.

5. The power pack module of claim 1, wherein the shell is telescopic and includes a plurality of cell apertures, each cell aperture dimensioned and positioned to correspond to one of the plurality of energy cells.

6. The power pack module of claim 5, wherein the weld plate includes a plurality of depressions, each depression configured to align with one of the plurality of energy cells, each depression including a projection configured to extend from the weld plate, through one of the plurality of cell apertures, and to contact a surface of one of the plurality of energy cells.

7. The power pack module of claim 1, wherein the power pack module includes a pair of busbar plates, each affixed to an exterior of the shell.

8. The power pack module of claim 7, wherein one busbar plate of the pair of busbar plates carries a negative electric charge, and one busbar plate of the pair of busbar plates carries a positive electric charge.

9. A power pack module, the power pack module comprising:
a power core including a plurality of energy cells;
a shell encasing the power core, the shell formed from a pair of interlocking half-shell members;
a weld plate affixed to each of the plurality of energy cells through at least one aperture in the shell;
a busbar plate affixed to the weld plate; and
a cover affixed to the shell, the cover enclosing the weld plate and the busbar plate.

10. The power pack module of claim 9, wherein the power pack module includes a pair of weld plates, a pair of busbar plates, and a pair of covers.

11. The power pack module of claim 10, wherein each of the pair of weld plates is affixed to an opposite side of the shell, each of the pair of busbar plates is affixed to one of the weld plates, and each of the pair of covers is affixed to an opposite side of the shell through one of the busbar plates.

12. The power pack module of claim 10, wherein each weld plate includes a tab, the tab dimensioned to fit within a tab recess in one of the half-shell members.

13. The power pack module of claim 10, wherein one weld plate in the pair of weld plates carries a positive electric charge, and one busbar plate in the pair of busbar plates carries a negative electric charge.

14. The power pack module of claim 9, wherein the support structure is made from a phase change material.

15. The power pack module of claim 9, wherein the weld plate is made of nickel.

16. The power pack module of claim 9, wherein each half-shell member includes a plurality of attachment regions formed in at least one side wall of the half-shell member, each attachment region including a slot, an aperture, and a hexagonal counterbore.

17. The power pack module of claim 9, wherein the weld plate is affixed to the power core by welding, and wherein the busbar plate is affixed to the weld plate by welding.

18. A method of constructing and arranging a plurality of power pack modules, the method including:
assembling a power core by disposing a plurality of energy cells into a support structure having a plurality of channels, each channel dimensioned to receive one energy cell;
encasing the power core in a shell;
coupling a weld plate to the power core by welding a plurality of regions of the weld plate to each of the energy cells through a plurality of apertures in the shell, wherein the power core, the shell and the weld plate constitute one of the plurality of power pack modules;
abutting the plurality of power pack modules in one of a vertical or horizontal direction; and
affixing a circuit board to one of the plurality of power pack modules such that the plurality of power pack modules are electronically connected.

19. The method of claim 18, wherein abutting the plurality of power pack modules in the vertical direction creates a stack, wherein a first busbar plate is affixed to a top of the stack, a second busbar plate is affixed to a bottom of the stack, and a pair of covers are coupled to each of the first and second busbar plates.

20. The method of claim 18, wherein when abutting the plurality of power pack modules in the horizontal direction, each power pack module may further include a busbar plate and a cover, wherein the busbar plate is welded to the weld plate, and wherein the cover is coupled to the busbar plate and the shell.
